(19) United States
(12) Patent Application Publication
(10) Pub. No.: US 2010/0013548 A1
(43) Pub. Date: Jan. 21, 2010

(54) POWER EFFICIENT CHARGE PUMP WITH CONTROLLED PEAK CURRENTS

(75) Inventor: Jeffrey G. Barrow, Tuscon, AZ (US)

Correspondence Address: KENYON & KENYON LLP, 1500 K STREET, NW, WASHINGTON, DC, 20005-1257, US

(73) Assignee: Analog Devices, Inc., Norwood, MA (US)

(21) Appl. No.: 12/176,300

(22) Filed: Jul. 18, 2008

(51) Int. Cl. G05F 3/00

(52) U.S. Cl. 327/536

(57) ABSTRACT

A charge pump which uses a current limit resistor to limit in-rush current and peak currents. An additional advantage of such a charge pump is that, when being coupled to a boost converter or other switching converter utilizing an inductive energy storage element, it may avoid unnecessary power dissipation caused by the current limit resistor.

### BACKGROUND INFORMATION

The present invention relates generally to charge pumps.

Charge pumps may produce a high voltage from a lower voltage source, and are often used in portable electronic devices, such as laptop computers, mobile phones, navigation devices, and media players. FIG. 1 illustrates a currently available charge pump. As shown, an input node 101 of a charge pump 100 may be coupled to an input voltage source Vᵢₙ. The charge pump 100 may provide an output voltage Vₒᵤₜ at its output node 102. Diodes D1 and D2 may be coupled in series between the input node 101 and the output node 102. A tank capacitor Cₜₐₙₖ may be coupled between the output node 102 and ground. The top of a flying capacitor C_{fly} may be coupled to the junction of the diodes D1 and D2, and the bottom of C_{fly} may be coupled to an oscillating voltage V_{osc}, provided at a node 103, via a peak current limit resistor Rₛ.

Consider one example in which, Vᵢₙ=10 v, Rₛ=10Ω, C_{fly}=100 nf, Cₜₐₙₖ=1 uf, and V_{osc} is a square wave with a 50% duty cycle and switching between 0 v and 10 v. When Vᵢₙ is applied to the circuit, both diodes D1 and D2 may briefly conduct, charging the tank capacitor Cₜₐₙₖ to 10 v. During a down stroke of the oscillating voltage V_{osc}, the input voltage Vᵢₙ may charge the flying capacitor C_{fly} and the charging current may flow from Vᵢₙ through the diode D1, the flying capacitor C_{fly}, and the peak current limit resistor Rₛ to V_{osc}. During an up stroke of the oscillating voltage V_{osc}, the flying capacitor C_{fly} may discharge into the tank capacitor Cₜₐₙₖ and the discharging current may flow from the node 103 to ground via the peak current limit resistor Rₛ, the flying capacitor C_{fly}, the diode D2 and the tank capacitor Cₜₐₙₖ. As a result, the output voltage Vₒᵤₜ may be pushed to V_{cfly}+10 v after several cycles, if parasitic effects in the circuit are neglected. The peak current limit resistor Rₛ may limit the flying capacitor peak current. For example, when Rₛ=10Ω, the flying capacitor peak current may be:

$${i}_{peak} ( {C}_{fly} ) = \frac{( Vin - {V}_{Cfly} )}{Rs} \approx \frac{( 10 v - 0 v )}{10 Ω} = 1 A \qquad ( 1 )$$

One problem of the charge pump in FIG. 1 is that it has no in-rush current protection and its in-rush current may become exceedingly large. At the moment Vᵢₙ is applied, the in-rush current may be calculated as follows according to an equation (2):

$${i}_{peak} = C \frac{d {V}_{i n}}{d t} \qquad ( 2 )$$

If one were to model the circuit of FIG. 1 using idealized devices and a perfect square wave for V_{osc}, C>0 and dVᵢₙ>0 and dt is approximately 0 and, therefore, the in-rush current, neglecting parasitic and other practical limitations, would be nearly infinite.

Therefore, it is desirable to provide a charge pump which has controlled in-rush current.

### BRIEF DESCRIPTION OF THE DRAWINGS

So that features of the present invention can be understood, a number of drawings are described below. It is to be noted, however, that the appended drawings illustrate only particular embodiments of the invention and are therefore not to be considered limiting of its scope, for the invention may encompass other equally effective embodiments.

FIG. 1 is a circuit schematic depicting a prior art charge pump.

FIG. 2 is a circuit schematic depicting a charge pump according to one embodiment of the present invention.

FIG. 3 is a circuit schematic depicting a charge pump according to one embodiment of the present invention.

FIG. 4 is a circuit schematic depicting a negative charge pump according to one embodiment of the present invention.

FIG. 5 is a circuit schematic depicting a multi-stage charge pump according to one embodiment of the present invention.

FIG. 6 is a circuit schematic depicting a charge pump used with a boost converter according to one embodiment of the present invention.

FIG. 7 is a circuit schematic depicting a charge pump used with a buck converter according to one embodiment of the present invention

### DETAILED DESCRIPTION OF EXAMPLE EMBODIMENTS

A charge pump of the present invention may overcome the disadvantages noted above by using its peak current limit resistor to limit its in-rush current. The peak current limit resistor may be removed from the discharging current path of the flying capacitor and put between the input voltage source and the flying capacitor. An additional advantage of such a charge pump is that, when being coupled to a boost converter or other switching regulator utilizing an inductor, it may avoid unnecessary power dissipation caused by the peak current limit resistor when the flying capacitor receives energy from the inductor.

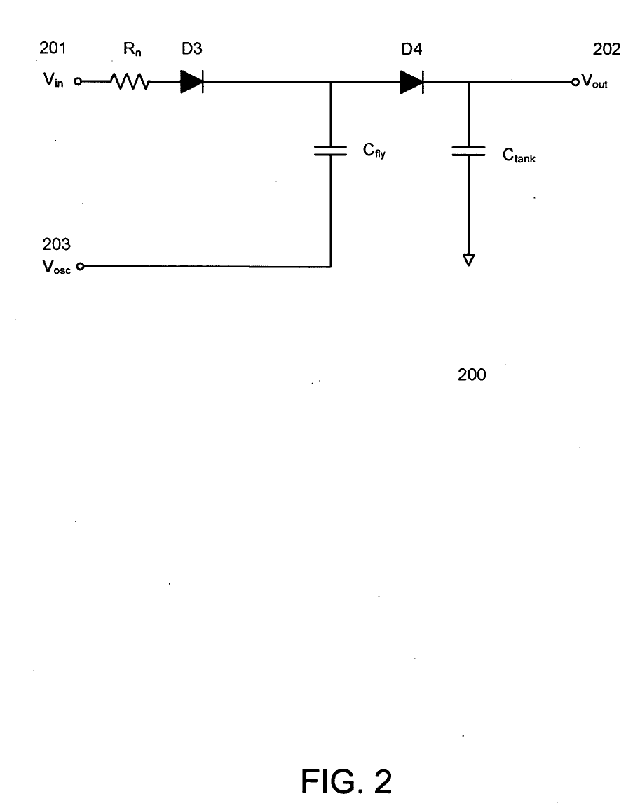

FIG. 2 is a circuit schematic depicting a charge pump according to one embodiment of the present invention. As shown, an input node 201 of a charge pump 200 may be coupled to an input voltage source Vᵢₙ. The charge pump 200 may provide an output voltage Vₒᵤₜ at its output node 202. A current limit resistor Rₙ and diodes D3 and D4 may be coupled in series between the input node 201 and the output node 202. A tank capacitor Cₜₐₙₖ may be coupled between the output node 202 and ground. The top of a flying capacitor C_{fly} may be coupled to the junction of the diodes D3 and D4, and the bottom of C_{fly} may be coupled to an oscillating voltage V_{osc} at a node 203.

During a down stroke of the oscillating voltage V_{osc}, the input voltage Vᵢₙ may charge the flying capacitor C_{fly} and the charging current may flow from Vᵢₙ to V_{osc} via the current limit resistor Rₙ, the diode D3, and the flying capacitor C_{fly}. During an up stroke of the oscillating voltage V_{osc}, the flying capacitor C_{fly} may discharge into the tank capacitor Cₜₐₙₖ and the discharging current may flow from the node 203 to ground via the flying capacitor C_{fly}, the diode D4 and the tank capacitor Cₜₐₙₖ.

Since the current limit resistor Rₙ is located between the input voltage source Vᵢₙ and the flying capacitor C_{fly}, and the flying capacitor charging current flows into the current limit resistor Rₙ before flowing into the flying capacitor C_{fly}, it may limit the in-rush current, in addition to the peak current.

Additional benefits of the charge pump 200 may include improved charge pump output impedance, and the possibility of protecting circuit elements D1, D2, and Vᵢₙ from catastrophic damage due to a charge pump in-rush current or output short circuit.

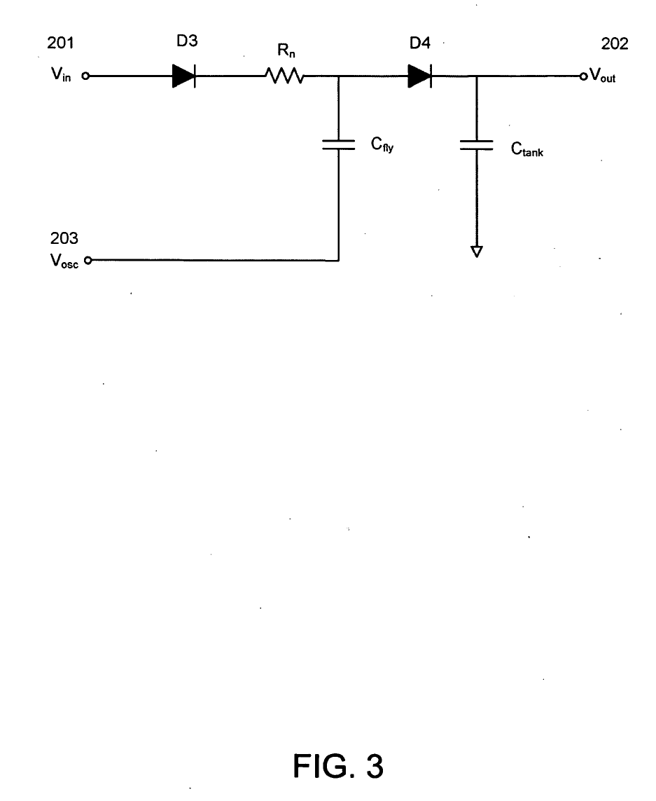

FIG. 2 describes the inventive charge pump, but is not intended to limit the location of the peak current limit resistor. As long as the peak current limit resistor is located between the input voltage source Vᵢₙ and the flying capacitor C_{fly}, it brings the advantages of limiting the peak current and in-rush current. For example, instead of the location shown in FIG. 2, the peak current limit resistor may be coupled between the cathode of the diode D3 and the junction of the diode D3 and the flying capacitor C_{fly}, as shown in FIG. 3.

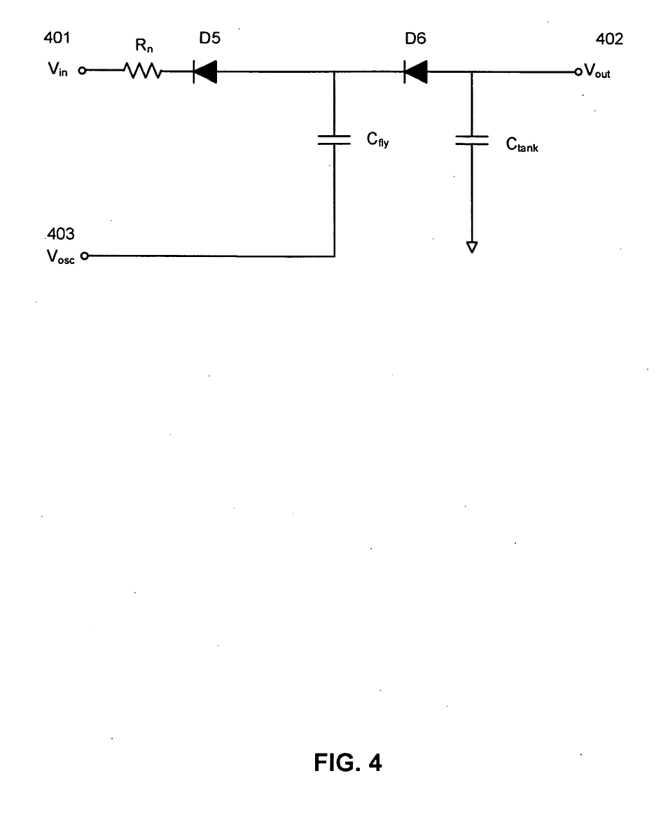

FIG. 4 illustrates another alternative design of the charge pump of the present invention: a negative charge pump used to supply a desired negative voltage. As shown, a voltage input may be applied to an input node 401, and a negative voltage output with respect to Vᵢₙ may be provided at an output node 402. Diodes D5 and D6 may be reverse-biased coupled between the input node 401 and the output node 402 in series, and a current limit resistor Rₙ may be coupled between the diode D5 and the input node 401. The input voltage may charge the flying capacitor C_{fly} via the current limit resistor Rₙ and the diode D5, and the flying capacitor C_{fly} may discharge via the diode D6 and a tank capacitor Cₜₐₙₖ. Similarly to the charge pumps shown in FIGS. 2 and 3, the current limit resistor Rₙ is located between the input voltage Vᵢₙ and the flying capacitor C_{fly}.

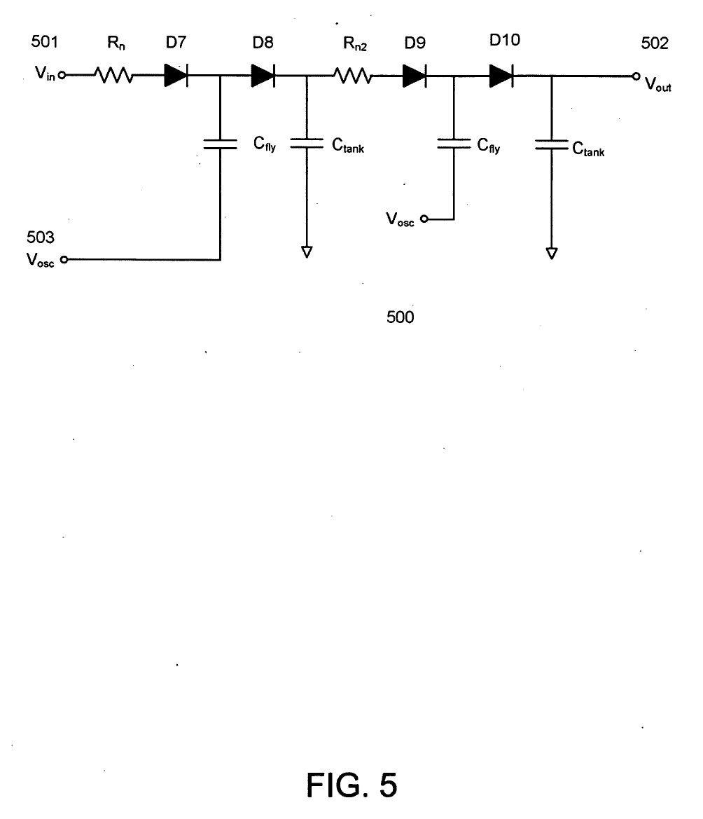

FIG. 5 is a circuit schematic depicting a multi-stage charge pump according to one embodiment of the present invention. As shown, the multi-stage charge pump 500 may receive an input voltage Vᵢₙ at an input node 501, provide an output voltage Vₒᵤₜ at an output node 502, and may have two stages. The first stage may include a current limit resistor Rₙ₁, diodes D7 and D8, a flying capacitor C_{fly1}, and a tank capacitor Cₜₐₙₖ₁. The second stage may include a current limit resistor Rₙ₂, diodes D9 and D10, a flying capacitor C_{fly2}, and a tank capacitor Cₜₐₙₖ₂. The current limit resistor Rₙ₁, diodes D7 and D8, the current limit resistor Rₙ₂, diodes D9 and D10 may be coupled in series between the input node 501 and the output node 502. The flying capacitor C_{fly1} may be coupled between the junction of diodes D7 and D8 and an oscillating voltage V_{osc}, the tank capacitor Cₜₐₙₖ₁ may be coupled between the output of the diode D8 and ground, the flying capacitor C_{fly2} may be coupled between the junction of diodes D9 and D10 and the oscillating voltage V_{osc}, and the tank capacitor Cₜₐₙₖ₂ may be coupled between the output of the diode D10 and ground.

During a down stroke of the oscillating voltage V_{osc}, the input voltage Vᵢₙ may charge the flying capacitor C_{fly1} via the current limit resistor Rₙ₁, and the diode D7, and may charge the flying capacitor C_{fly2} via the diode D8, the current limit resistor Rₙ₂ and the diode D9. During an up stroke of the oscillating voltage V_{osc}, the flying capacitor C_{fly1} may discharge via the diode D8 and the tank capacitor Cₜₐₙₖ₁, and the flying capacitor C_{fly2} may discharge via the diode D10 and the tank capacitor Cₜₐₙₖ₂. Since the charging current flows into the current limit resistors Rₙ₁ and Rₙ₂ before it flows into the flying capacitors, it may limit the in-rush current.

It should be understood that the multi-stage charge pump may use only one peak current limit resistor, instead of one for each stage.

In the multi-stage charge pump 500, the first stage and the second stage are shown as being coupled in series between the input node 501 and the output node 502. It should be understood that they may be coupled between the input and the output node in parallel too. In addition, the multi-stage charge pump may have three or more stages, as necessary.

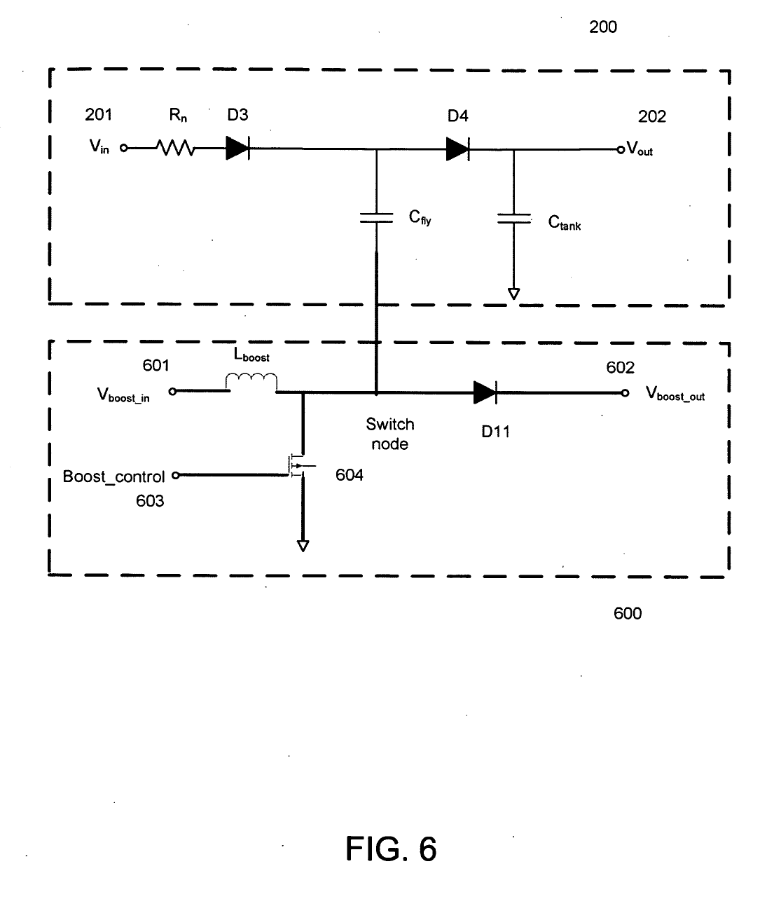

FIG. 6 is a circuit schematic depicting a charge pump used with a boost converter according to one embodiment of the present invention. A boost converter is able to provide a greater voltage to a load than is provided by an input voltage. The combination of a charge pump and a boost converter may be used to provide two voltages, e.g., Vₒᵤₜ at the output node 202 of the charge pump 200 and V_{boost}_{_{—}}ₒᵤₜ at an output node 602 of a boost converter 600.

The boost converter 600 may receive a DC input voltage V_{boost}_{_{—}}ᵢₙ at an input node 601, and provide the output voltage V_{boost}_{_{—}}ₒᵤₜ at its output 602. An inductor L_{boost} and a diode D11 may be coupled in series between the input node 601 and the output node 602. A transistor 604 may be coupled between the output of the inductor L_{boost} and ground, and a control signal Boost_control may be used to turn the transistor 604 on and off. A switch node may be any point between the output of the inductor and the input of the diode D11.

Looking at the boost converter 600 alone first, when the transistor 604 is turned on, the voltage of the switch node may be down to 0 v, and the input voltage V_{boost}_{_{—}}ᵢₙ may charge the inductor L_{boost}. When the transistor 604 is turned off, the inductor L_{boost} may discharge via the diode D11. The voltage at the switch node may fly up to V_{boost}_{_{—}}ₒᵤₜ, if parasitic effects introduced by the diode D11 are ignored. Thus, the voltage at the switch node may be pulses switching between 0 v and V_{boost}_{_{—}}ₒᵤₜ, and its duty cycle may be determined by the duty cycle of the control signal Boost_control of the transistor 604.

In the embodiment shown in FIG. 6, the switch node may replace the node 203 in FIG. 2 and provide V_{osc} to the charge pump 200. When the transistor 604 is turned on, the voltage at the switch node is 0 v, and the flying capacitor charging current may flow from Vᵢₙ to ground via Rₙ, D3, C_{fly}, and the transistor 604. When the transistor 604 is turned off, the voltage at the switch node may fly up to V_{boost}_{_{—}}ₒᵤₜ, and the flying capacitor may discharge through the diode D4 and the tank capacitor Cₜₐₙₖ.

In addition to limit the peak current and the in-rush current, the charge pump 200 is more power efficient than the charge pump 100 when being coupled to a boost converter or other switching converter utilizing an inductor. Since the current limit resistor is removed from the discharging current path of the flying capacitor C_{fly}, it may not waste the energy stored in the inductor L_{boost} when the flying capacitor receives energy from that inductor.

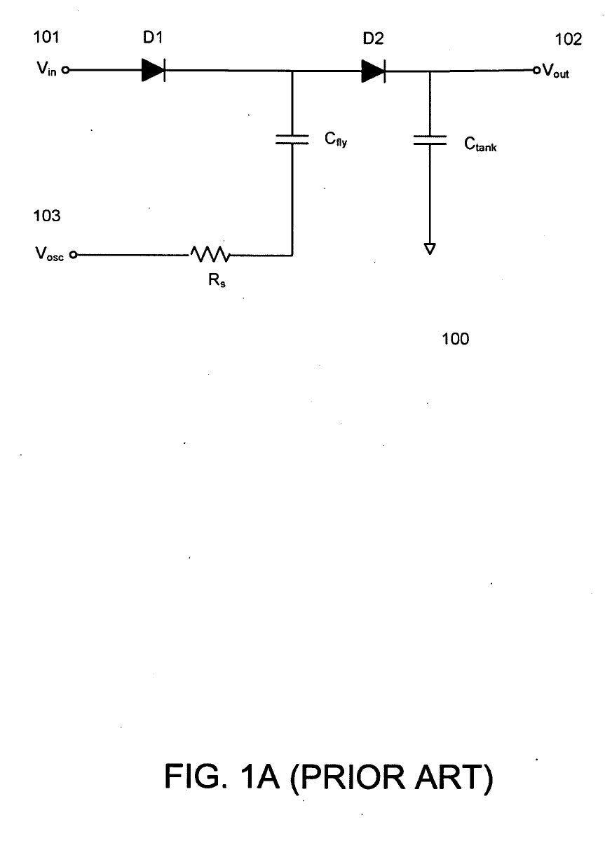

Power dissipation in Rₛ in FIG. 1 may be calculated as follows:

Due to conservation of charge, C_{fly}'s amp-seconds during an upstroke must equal its amp-seconds during a down stroke under equilibrium operating conditions.

I_{cfly}_{_{—}}ᵤₚₛₜₒₖₑ*tᵤₚₛₜᵣₒₖₑ=I_{cfy}_{_{—}}_{down}_{_{—}}ₛₜᵣₒₖₑ*t_{down}_{_{—}}ₛₜᵣₒₖₑ (3)

Accordingly, all charge delivered as output load current must pass into, and out of the flying capacitor, C_{fly}, whereby the average current over one full cycle in each direction is equal to the output current. Neglecting diode forward voltage drops and other parasitics, the maximum power dissipation due to Rₛ may be:

P_{diss}_{_{—}}_{Rs}_{_{—}}ₘₐₓ=(Vₒᵤₜ_{_{—}}_{open circuit}−Vₒᵤₜ_{_{—}}_{closed}_{_{—}}_{circuit})*2*Iₒᵤₜ (4)

Power dissipation in Rₙ in FIG. 6 may be calculated as follows:

Since the current limit resistor Rₙ is removed from the discharging current path of the flying capacitor C_{fly}, it may not waste the energy stored in the inductor L_{boost} when the flying capacitor receives energy from that inductor. Furthermore, the current limit resistor Rₙ conducts only during the upstroke or down stroke but not both strokes depending on placement. Neglecting diode forward voltage drops and other parasitics, the maximum power dissipation due to Rₙ may be:

P_{diss}_{_{—}}_{Rn}_{_{—}}ₘₐₓ=(Vₒᵤₜ_{_{—}}_{open circuit}−Vₒᵤₜ_{_{—}}_{closed}_{_{—}}_{circuit})*Iₒᵤₜ (5)

In an example of a typical charge pump, if Iₒᵤₜ=0.1 A, C_{fly}=0.1 uF, Rₙ=10Ω and V_{osc} operates at 1 MHz, then the charge pump will have a minimum output impedance of:

Zₒᵤₜ_{_{—}}ₘᵢₙ=1/(C_{fly}*Frequency)=1/(0.1 uF*1 MHz)=10Ω (6)

and,

Vₒᵤₜ_{_{—}}_{open circuit}−Vₒᵤₜ_{_{—}}_{closed}_{_{—}}_{circuit}=Iₒᵤₜ*Zₒᵤₜ_{_{—}}ₘᵢₙ=0.1 A*10Ω=1V (7)

Therefore, the maximum power dissipation in Rₛ may be equal to,

P_{diss}_{_{—}}_{Rs}_{_{—}}ₘₐₓ=(Vₒᵤₜ_{_{—}}_{open circuit}−Vₒᵤₜ_{_{—}}_{closed}_{_{—}}_{circuit})*2*Iₒᵤₜ=1V*2*0.1 A=200 mW (8)

Whereas, the maximum power dissipation in Rₙ may be equal to,

P_{diss}_{_{—}}_{Rn}_{_{—}}ₘₐₓ=(Vₒᵤₜ_{_{—}}_{open circuit}−Vₒᵤₜ_{_{—}}_{closed}_{_{—}}_{circuit})*2*Iₒᵤₜ=1V*0.1A=100 mW (9)

Accordingly, a maximum possibility of 50% improvement in system power dissipation over prior art in FIG. 1 while preserving all benefits of peak current limiting. When the charge pump is used in circuits of portable electronic devices, the power dissipation may result in shorter battery life and thus restrict the use of the devices. By reducing power dissipation caused by the charge pump, performance of the portable electronic device may be improved.

Although the current limit resistor Rₙ is off the discharging current path of C_{fly}, the embodiment shown in FIG. 6 may not suffer from a peak discharging current, since the inductor L_{boost} is on the discharging current path and the inductor current cannot change instantaneously.

A further advantage of the embodiment shown in FIG. 6 is that it may have better output impedance. When the prior art charge pump in FIG. 1 is coupled to a boost converter, since the peak current limit resistor Rₛ is coupled in series with the flying capacitor C_{fly}, the selection of Rₛ needs to meet the following requirements:

RₛC_{fly}<Tₒₙ, and RₛC_{fly}<T_{off}, (10)

wherein Tₒₙ is the on time of the boost converter and T_{off} is the off time of the boost converter.

As a result, the off time T_{off}, which is shorter than the on time Tₒₙ of the boost converter, may dictate the maximum value of Rₛ.

In the embodiment shown in FIG. 6, since the current limit resistor Rₙ is no longer coupled in series with the flying capacitor C_{fly}, the selection of Rₙ only needs to meet the following requirement:

RₙC_{fly}<Tₒₙ (11)

Accordingly, Rₙ may be flexibly selected to improve output impedance of the circuit shown in FIG. 6.

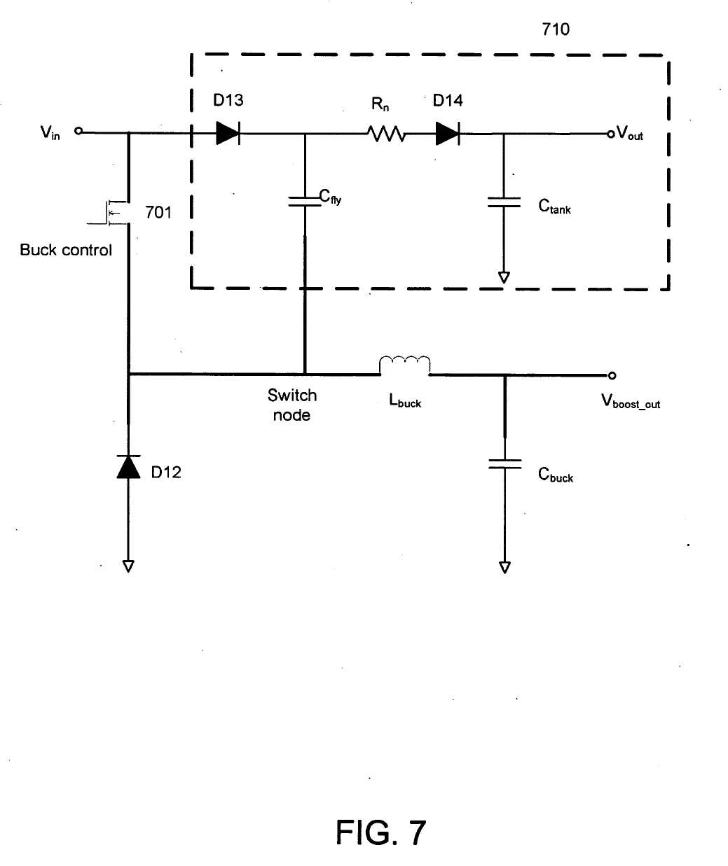

Alternatively, the oscillating voltage V_{osc} may be provided by the switch node of a buck converter or other switching converter using an inductor as an energy storage element. FIG. 7 is a circuit schematic depicting a charge pump used with a buck converter according to one embodiment of the present invention. A buck converter is able to provide a lower voltage to a load than is provided by an input voltage. The combination of a charge pump and a buck converter may be used to provide two voltages, e.g., Vₒᵤₜ at the output node of the charge pump 710 and V_{buck}_{_{—}}ₒᵤₜ at an output node of the buck converter.

The buck converter may include a transistor 701, a diode D12, an inductor L_{buck}, and a capacitor C_{buck}. The buck converter may be coupled to the input voltage Vᵢₙ, and provide the output voltage V_{buck}_{_{—}}ₒᵤₜ at its output. The transistor 701 may be controlled by a voltage Buck_control. The charge pump 710 may include C_{fly}, Cₜₐₙₖ, diodes D13 and D14 and a current limit resistor Rₙ. The switch node of the charge pump 710 may be coupled to the junction of L_{buck} and D12.

When the transistor 701 is turned on, C_{fly} may discharge into Cₜₐₙₖ through the current limit resistor Rₙ and the diode D14. The current limit resistor Rₙ may limit an in-rush current flowing through Vᵢₙ, D13, Rₙ, D14 and Cₜₐₙₖ, and may limit the peak current flowing through the transistor 701, C_{fly}, Rₙ, D14 and Cₜₐₙₖ.

When the transistor 701 is turned off, the inductor L_{buck} may pull C_{fly} negative until the diode D12 turns on. The charging current path may include the inductor L_{buck}, C_{fly}, D13 and Vᵢₙ. Since the current limit resistor Rₙ is off the charging current path, it may not waste the energy stored in the inductor L_{buck}.

Further embodiments are also possible, for example, by combining various ones of the embodiments described herein. Also, although FIG. 6 uses a DC-DC converter, it should be understood that other forms of switching converters, e.g., an AC-AC, DC-AC, or AC-DC converter, could be coupled to a charge pump with all of the advantages of this invention.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A charge pump circuit, having input terminals for an input voltage and an oscillating voltage and an output terminal for an output voltage, the circuit comprising:
a flying capacitor provided in a circuit path between the terminal for the oscillating input voltage and the output terminal,
a tank capacitor coupled to the output terminal and ground, and
a current limiter provided in a circuit path between the terminal for the input voltage and the output terminal but outside the circuit path between the terminal for the oscillating input voltage and the output terminal.

2. The charge pump circuit of claim 1, wherein the input voltage charges the flying capacitor via the current limiter during a down stroke of the oscillating input voltage.

3. The charge pump circuit of claim 1, wherein the flying capacitor discharges into the tank capacitor during an up stroke of the oscillating input voltage.

4. The charge pump circuit of claim 1, further comprising: a first diode which is in the circuit path between the terminal for the oscillating input voltage and the output terminal and is coupled between the flying capacitor and the tank capacitor.

5. The charge pump circuit of claim 4, wherein the diode is reverse-biased.

6. The charge pump circuit of claim 4, further comprising: a second diode provided in the circuit path between the terminal for the input voltage and the output terminal.

7. The charge pump circuit of claim 6, wherein the second diode is coupled between the input of the current limiter and the terminal for the input voltage.

8. The charge pump circuit of claim 6, wherein the second diode is coupled at the output of the current limiter.

9. The charge pump circuit of claim 1, further comprising:
a second flying capacitor provided in the circuit path between the terminal for the oscillating input voltage and the output terminal,
a second tank capacitor coupled to the output terminal and ground, and
a second current limiter provided in a circuit path between the terminal for the input voltage and the output terminal but outside the circuit path including the terminal for the oscillating input voltage, the second flying capacitor and the output terminal.

10. The charge pump circuit of claim 1, wherein the terminal for the oscillating input voltage is coupled to a boost converter.

11. The charge pump circuit of claim 10, wherein the boost converter comprises:
an inductor provided in a circuit path between a boost input voltage terminal and a boost output voltage terminal, and a switch provided in a circuit path between the output of the inductor and ground and switched on and off by a boost control signal,
wherein the terminal for the oscillating input voltage is coupled between the output of the inductor and the boost output voltage terminal.

12. A charge pump, comprising:
an input node for receiving an input voltage Vᵢₙ;
an output node for providing an output voltage Vₒᵤₜ;
a switching node for receiving an oscillating voltage V_{osc};
a first capacitor coupled between the output node and ground;
a second capacitor, being charged by a charging current from the input node, and discharging through the first capacitor; and
a current limiter, which limits the in-rush current of the charge pump, but is outside a discharging current path of the second capacitor.

13. The charge pump of claim 12, further comprising: a first diode which is on the discharging current path of the second capacitor and is coupled between the second capacitor and the first capacitor.

14. The charge pump of claim 13, wherein the first diode is reverse-biased.

15. The charge pump of claim 12, further comprising: a second diode coupled in series with the current limiter.

16. The charge pump of claim 15, wherein the second diode is coupled between the current limiter and the input node.

17. The charge pump of claim 12, wherein the switching node receives the oscillating voltage V_{osc} from a boost converter.

18. The charge pump of claim 12, further comprising:
a third capacitor coupled between the output node and ground;
a fourth capacitor, being charged by the charging current from the input node, and discharging through the third capacitor; and
a current limiter, which limits the charging current of the fourth capacitor, but is outside a discharging current path of the fourth capacitor.

19. The charge pump of claim 17, wherein the boost converter comprises:
an inductor provided in a circuit path between a boost input voltage terminal and a boost output voltage terminal, and
a switch provided in a circuit path between the output of the inductor and ground and switched on and off by a boost control signal,
wherein the terminal for the oscillating input voltage is coupled between the output of the inductor and the boost output voltage terminal.

20. A charge pump, comprising:
an input node for receiving an input voltage Vᵢₙ;
an output node for providing an output voltage Vₒᵤₜ;
a switching node for receiving an oscillating voltage V_{osc} from a buck converter;
a first capacitor coupled between the output node and ground;
a second capacitor discharging through the first capacitor; and
a current limiter, which limits the in-rush current of the charge pump, but is outside a charging current path of the second capacitor.
